(19) United States
(12) Patent Application Publication
(10) Pub. No.: US 2008/0133407 A1
(43) Pub. Date: Jun. 5, 2008

(54) Methods and Systems for Determining and Displaying Payment Options in an Electronic Payment System

(75) Inventors: Lawrence Otice Guillory, Suwanee, GA (US); Mary Catherine Herbeck, Columbus, OH (US); Donald Kenneth Hobday, Blacklick, OH (US); Geiger Ferrell Lee, Gahanna, OH (US); William E. Rasche, Dublin, OH (US); Todd Nathaniel Roberts, Granville, OH (US); Richard A. Stratton, Westerville, OH (US); Cheryl L. Ward, Hilliard, OH (US)

Correspondence Address: SUTHERLAND II, SUTHERLAND, ASBILL & BRENNAN, LLC, 999 PEACHTREE STREET, ATLANTA, GA, 30309, US

(73) Assignee: CheckFree Corporation, Norcross, GA (US)

(21) Appl. No.: 11/743,390

(22) Filed: May 2, 2007

Related U.S. Application Data
(63) Continuation-in-part of application No. 11/565,322, filed on Nov. 30, 2006.

(51) Int. Cl. G06Q 30/00

(52) U.S. Cl. 705/40

(57) ABSTRACT

A system and method for determining and displaying payment options in an electronic payment system is disclosed. A payee for a payor is identified. Prior to receiving a payment request to submit a payment to the payee on behalf of the payor, at least one funding method is identified from a list of potential funding methods. The at least one funding method is a funding method that is available to the payor for the payment to the payee, and the identification of the at least one funding method is based at least in part on at least one risk-based criteria. An interface screen is then generated for displaying at least one option to pay the payee, wherein the at least one option is associated with the at least one funding method.

### CROSS REFERENCE TO RELATED APPLICATIONS

The present application is a continuation-in-part of co-pending U.S. application Ser. No. 11/565,322, filed Nov. 30, 2006, entitled “Methods and Systems for the Determination and Display of Payment Lead Time in an Electronic Payment System,” the disclosure of which is entirely incorporated by reference herein.

### FIELD OF THE INVENTION

The present invention relates generally to methods and systems for determining and displaying available options for payment in an electronic payment system and the processing of a received payment request.

### BACKGROUND OF THE INVENTION

Electronic payment systems are known in the art. An electronic payment system may include a service provider that makes payments to a payee on behalf of a payor. A payment request is submitted to the service provider by a payor or on behalf of a payor. The payment request includes information identifying the payee and an amount of the payment to be made. Once the payment request is received, the service provider processes the request to complete the payment on behalf of the payor.

In processing a payment request, the service provider typically submits a payment on behalf of the payor to the payee utilizing a funding method such as a bank account or a credit card. The funding method that is utilized is typically specified by the payment request or determined following the receipt of the payment request. After determining the funding method to be utilized, the service provider may perform an analysis of the risk of making a payment on behalf of the payor. This risk analysis may lead to restrictions on the ability of the service provider to utilize the selected funding method. These restrictions may result in the selection of a different funding method.

Each funding method may also have a payment lead time associated with it. The lead time of a payment is the time that is required subsequent to payment request processing to ensure timely delivery of a payment to a payee. The lead time of two different funding methods may be different. Service providers have been attempting to shorten the lead time for various funding methods; however, the definitive determination of the funding method and its associated lead time may not be known until the payment request is received.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a network utilized in conjunction with a payment service provider, according to an illustrative embodiment of the present invention.

FIG. 2 is a control unit utilized by a payment service provider, according to an illustrative embodiment of the present invention.

FIG. 3 is an exemplary flowchart of the operation of the control unit of FIG. 2, according to an illustrative embodiment of the present invention.

FIG. 4A is an exemplary flowchart of the control logic utilized by the control unit of FIG. 2 to determine available funding methods, according to an illustrative embodiment of the present invention.

FIG. 4B-4D are tables depicting exemplary results of the processing steps of FIG. 4A, according to an illustrative embodiment of the present invention.

FIG. 5 is an exemplary bill presentment graphical user interface screen provided to a payor by a payment service provider, according to an illustrative embodiment of the present invention.

FIG. 6 is an exemplary flowchart of the control logic utilized by the control unit of FIG. 2 to process payment requests received from a payor, according to an illustrative embodiment of the present invention.

FIGS. 7A-7B are exemplary graphical user interface screens provided to a payor by a payment service provider to receive information concerning a payment request, according to an illustrative embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams of systems, methods, apparatuses and computer program products according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the combination of computing hardware and instructions which execute thereon constitute means for implementing the functionality of each block of the block diagrams, or combinations of blocks in the block diagrams discussed in detail in the descriptions below.

These computer program instructions may also be stored in a computer-readable memory to constitute an article of manufacture. The article of manufacture may be used in conjunction with a computing device to cause the instructions from the article of manufacture to be loaded onto and executed by the computing device, and thereby implement the function specified in the block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by general or special purpose hardware-based computer systems that perform the specified functions or steps, or combinations of general or special purpose hardware and computer instructions.

The inventions may be implemented through one or more application programs running on one or more operating systems of one or more computers. The inventions also may be practiced with diverse computer system configurations, including hand-held devices, multiprocessor systems, microprocessor based or programmable consumer electronics, mini-computers, mainframe computers, etc.

Application programs that are components of the invention may include modules, objects, data structures, etc., that perform certain tasks or implement certain abstract data types. A particular application program (in whole or in part) may reside in a single or multiple memories. Likewise, a particular application program (in whole or in part) may execute on a single or multiple computers or computer processors. Exemplary embodiments of the present invention will hereinafter be described with reference to the figures, in which like numerals indicate like elements throughout the several drawings.

According to an embodiment of the present invention, systems and methods are disclosed for identifying funding methods available to a payor for making a payment on behalf of a payor. The identification or determination of available funding methods may be made by analyzing one or more risk-based criteria prior to receiving a payment request from the payor. Either an indication that funding methods are available or a list of available funding methods may then be disclosed to the payor, and the payor may utilize at least one of the available funding methods in submitting a request that a payment be made to a payee. The payor may also be notified of the ability to have an emergency payment or immediate payment submitted to a payee on behalf of the payor. An emergency payment is a payment for which the payor will receive same-day credit with the payee. In other words, it may be recognized by a payee that an emergency payment has been submitted by or on behalf of the payor on the date that the emergency payment is authorized. An emergency payment may be submitted electronically on behalf of a payor. The ability to request emergency payments may assist a payor in avoiding late charges and other penalties associated with submitting a payment to a payee after a specified due date.

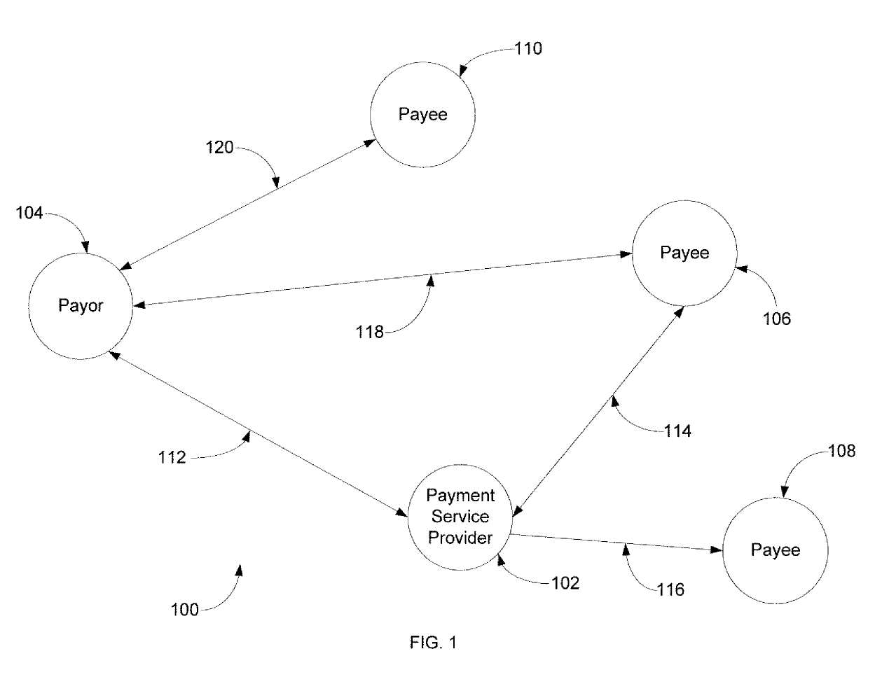

FIG. 1 provides an illustrative embodiment of a network 100 that may be utilized in conjunction with a payment service provider 102 in accordance with the present invention. As shown in FIG. 1, the network 100 may include a payment service provider 102, a payor 104, a first payee 106, a second payee 108, and a third payee 110. For purposes of describing the present invention, only a single payor 104 and three payees 106, 108, and 110 are shown; however, it will be understood by those of skill in the art that the network 100 may include any number of payors and payees.

Various components of the network 100 may be in communication with one another via communications links 112, 114, 116, 118, and 120. It will be understood that each of the communications links 112, 114, 116, 118, and 120 could be any type of communications link such as, for example, a network-based communications link over the Internet. Additionally, the network 100 may be any network including, but not limited to, the Internet, a local area network, a wide area network, a public switched telephone network, a wireless network, or any combination thereof.

The payor 104 may be in communication with the payment service provider 102 via a first communications link 112. According to an aspect of the present invention, the payor 104 may submit payment requests to the payment service provider 102. The payment requests may be requests for the payment service provider 102 to submit a payment to the first payee 106 or the second payee 108 on behalf of the payor 104. A payment made by the payment service provider 102 may be any type of payment including, but not limited to, payment of a bill issued by a payee, a point-of-sale payment, a payment for goods or services purchased via a network interface, and a person-to-person payment. In addition to a payment submitted to a payee, the payment service provider 102 may also issue remittance advice to the payee. The term remittance may be used to encompass the combination of a payment and remittance advice associated with the payment. The remittance advice may be a description of the breakdown of a particular payment or credit that allows proper payment posting to specific accounts or sub-accounts in a payee's accounts receivable system.

The payment service provider 102 may submit one or both of electronic and paper payments to the first payee 106 and/or the second payee 108. For an electronic payment, the payment service provider 102 may direct that funds be electronically credited to a deposit account belonging to the first payee 106 or the second payee 108 and that funds be electronically debited from a deposit account belonging to the payor 104. For a paper payment, the payment service provider 102 may prepare a paper instrument (e.g., check or draft) and deliver it to the first payee 106 or the second payee 108.

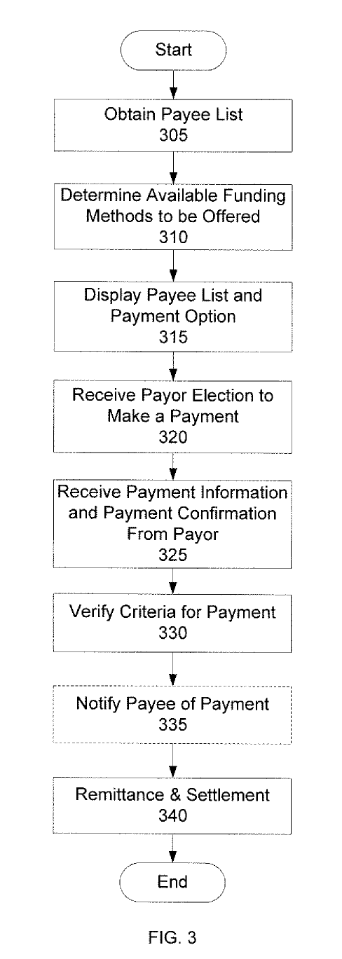

In accordance with an aspect of the present invention, the payment service provider 102 may also electronically submit emergency payments or immediate payments to the first payee 106 and/or the second payee 108, as explained in greater detail below with reference to FIGS. 3-8. An emergency payment may ensure that the payor 104 is given same-day credit for the payment by a payee. In other words, an emergency payment may ensure that the payee recognizes that a payment was made by the payor 104 or on behalf of the payor 104 on the day that a payment request is submitted by the payor 104. Accordingly, an emergency payment may assist a payor 104 in the avoidance of fees or penalties associated with late payments.

The payment service provider 102 may also be in communication with the first payee 106 and the second payee 108. As shown in FIG. 1, the payment service provider 102 may be in communication with the first payee 106 via a second communications link 114 and the payment service provider 102 may be in communication with the second payee 108 via a third communications link 116. It will be understood by those of skill in the art that the second communications link 114 may not be the same type of communications link as the third communications link 116. For example, the payment service provider 102 may be in communication with the first payee 106 via a network connection, and the payment service provider 102 may not be in communication with the second payee 108 via a network connection. Instead, the payment service provider 102 may only be in communication with the second payee 108 via more traditional means such as, for example, standard mail or postal service. Such a situation might exist if the second payee 108 is only capable of receiving a paper payment from the payor 104 or payment service provider 102.

It will also be understood that the payment service provider 102 may also be capable of presenting bills to a payor 104. For example, the payment service provider 102 may receive billing information from the first payee 106. The billing information may include detailed and/or summary billing information of a bill issued by the first payee 106 for the payor 104. The payment service provider 102 may receive the billing information from the first payee 106 via the second communications link 114 and then electronically present detailed and/or summary billing information to the payor 104 via the first communications link 112.

In accordance with the present invention, the payor 104 may be in direct communication with payees via communications links. As shown in FIG. 1, the payor 104 may be in communication with the first payee 106 via a fourth communications link 118 and the payor 104 may be in communication with a third payee 110 via a fifth communications link 120. The payor 104 may submit payments directly to one or both of the first payee 106 and the third payee 110 instead of having payments submitted by the payment service provider 102. The fourth communications link 118 and the fifth communications link 120 may be network-based communications links and/or more traditional communications links as described above. It will further be understood that one or both of the first payee 106 and the third payee 110 may also be capable of presenting billing information directly to the payor 104 rather than transmitting billing information to the payment service provider 102 for presentment to the payor 104.

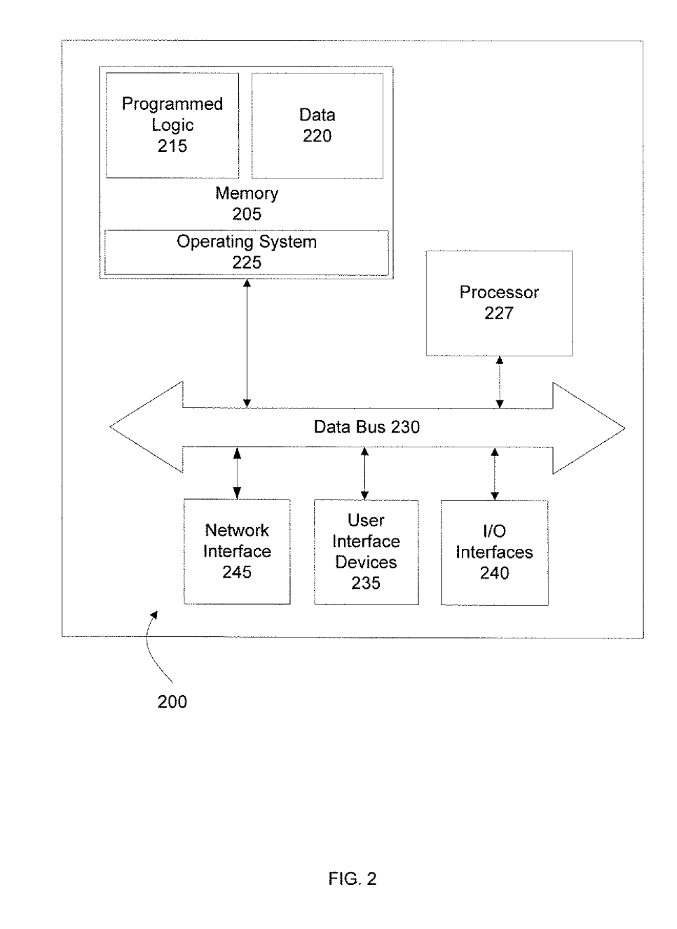

The payment service provider 102, the payor 104, and the payees 106, 108, and 110 may each incorporate one or more network stations and the combination of network stations may support the network 100. Each network station may include a control unit 200 that coordinates its communications with the network 100, as described in greater detail below with reference to FIG. 2. It will be understood, however, that each entity does not necessarily have to incorporate a network station and/or include a control unit. For example, a payee that is not capable of receiving an electronic payment may not incorporate a network station and/or include a control unit that coordinates its communications with the network 100. In other words, a payee that is only capable of receiving a paper payment need not necessarily include a network station or a control unit.

FIG. 2 is a block diagram of a control unit 200 utilized by a payment service provider 102, according to an illustrative embodiment of the present invention. It will be understood that the payor 104 and payees 106, 108, and 110 may utilize similar control units as that utilized by the payment service provider 102.

The control unit 200 may include a memory 205 that stores programmed logic 215 (e.g., software) in accordance with the present invention. The memory 205 may also include data 220 that may be utilized in the operation of the present invention and an operating system 225. A processor 227 may utilize the operating system 225 to execute the programmed logic 215, and in doing so, may also utilize the data 220. A data bus 230 may provide communication between the memory 205 and the processor 227. Users may interface with the control unit 200 via a user interface device(s) 235 such as a keyboard, mouse, control panel, display, microphone, speaker, or any other devices capable of communicating information to or from the control unit 200. The control unit 200 may be in communication with other external devices via I/O Interfaces 240. Additionally, the control unit 200 may be in communication with the network 100 and other devices or network stations via a network interface 245. Further the control unit 200 and the programmed logic 215 implemented thereby may comprise software, hardware, firmware or any combination thereof. Although the control unit 200 is described herein as having a single processor 227, it will be appreciated that the control unit 200 may include any number of processors and/or network-based appliances. Additionally, it will be understood that different functions performed by the control unit 200 may be performed by different processors or different network-based appliances of the control unit 200. The control unit 200 may be a personal computer, mainframe computer, minicomputer, PDA, cell phone, television set top box, web box, or any other computer device or any combination thereof. It will also be appreciated that more than one memory device may be included in the control unit 200 or in communication with the control unit 200. The one or more memory devices may also be associated with one or more databases. The one or more databases may include data or information relating to the various payors, payees, and/or other entities associated with the network. The one or more databases may further include data or information relating to relationships between the various payors, payees, and/or other entities.

According to an aspect of the present invention, the payment service provider 102 may submit payments to the first payee 106 and the second payee 108 on behalf of the payor 104. Prior to submitting a payment on behalf of the payor 104, the payment service provider 102 may receive a payment request from the payor 104 or on behalf of the payor 104. If a payment request is received on behalf of the payor 104, the payment request may be received from any entity acting on behalf of the payor 104 such as, for example, a sponsor or consumer service provider of the payor 104 or a financial institution at which the payor 104 has an account. The payment request may be received by the payment service provider 102 at any point in time prior to the submission of a payment to the first payee 106 or the second payee 108. Additionally, a single payment request may request that multiple payments be made to one or more of the first payee 106 and the second payee 108. For example, a payment request may direct or request the payment service provider 102 to submit a payment to the first payee 106 at the end of each month. As another example, a single payment request may direct or request the payment service provider 102 to submit a payment to each payee identified by the payor 104 or to each payee for which the payment service provider 102 has received billing information indicating that a payment should be received from the payor 104. It will also be appreciated that the payment service provider 102 may submit a single payment in response to more than one received payment request. For example, the payment service provider 102 may submit a single payment, also referred to as a consolidated payment in this example, to a payee on behalf of multiple payors.

According to an aspect of the present invention, the payment service provider 102 may also receive and process requests from the payor 104 or an entity acting on behalf of the payor 104 to submit emergency payments or immediate payments to the first payee 106 and/or the second payee 108, as explained in greater detail below with reference to FIGS. 3-8.

The payor 104 may transmit payment requests to the payment service provider 102 via the first communications link 112. A network connection may be established between the payor 104 and the payment service provider 102. For example, a network connection may be established between a control unit of the payor 104 and a control unit of the payment service provider 102. It will be appreciated that, if an entity submits a payment request on behalf of the payor 104, the entity may transmit the payment request to the payment service provider 102.

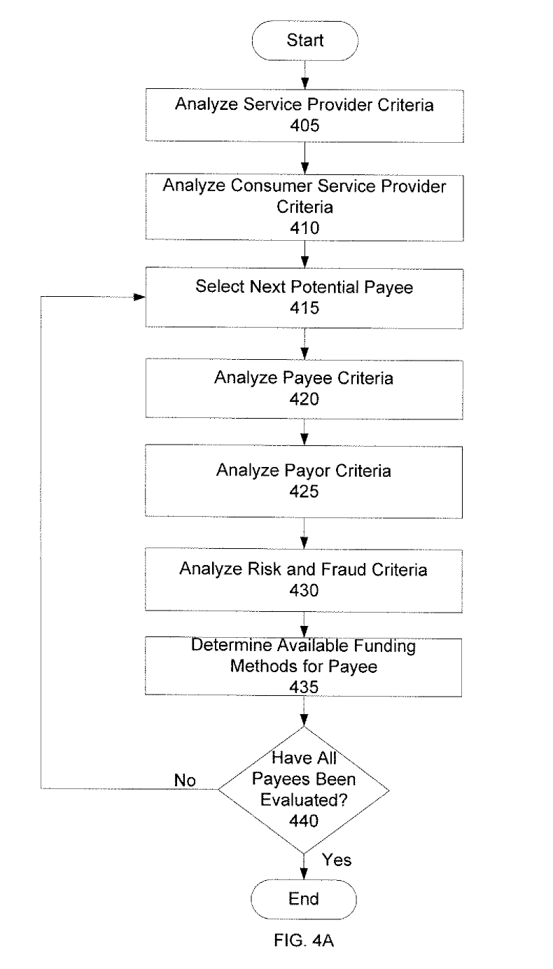

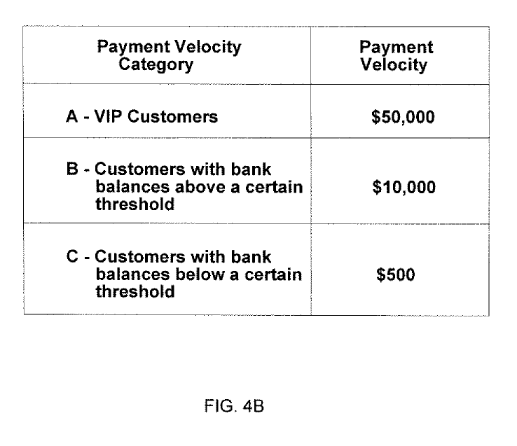

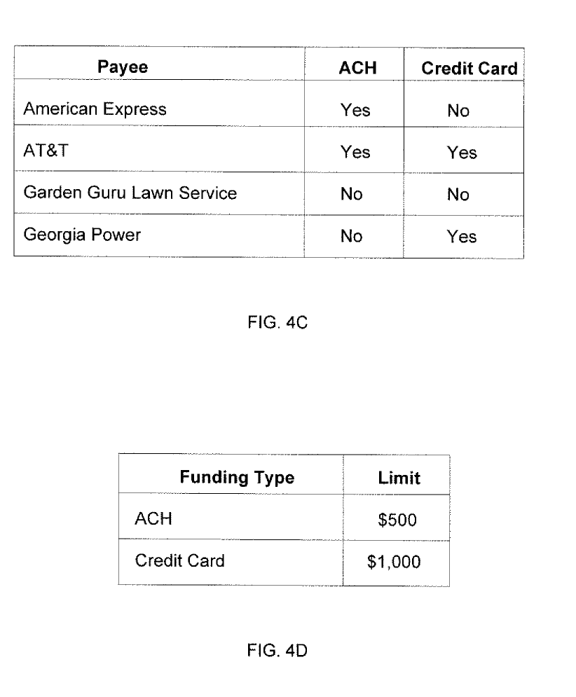

According to another aspect of the present invention, the payment service provider 102 may identify funding methods available to the payor 104 for making a payment on behalf of the payor 104 prior to receiving a payment request from the payor 104. As utilized herein, a funding method may be a funding account or a type of funding account that may be utilized to submit a payment on behalf of the payor 104. For example, a funding method may be a credit card account or a bank account associated with the payor 104. The identification or determination of available funding methods may be made by analyzing one or more risk-based criteria, as discussed in greater detail below with reference to FIG. 4A. Either an indication that funding methods are available or a list of available funding methods may then be disclosed to the payor 104, and the payor 104 may utilize or select at least one of the available funding methods in submitting a payment request.

According to another aspect of the present invention, the payment service provider 102 may identify payment methods available to the payor 104 for making a payment on behalf of the payor 104 prior to receiving a payment request from the payor 104. As utilized in herein, a payment method is not the same as a funding method. A payment method may be a form of payment or payment processing that is utilized to make a payment on behalf of a payor 104. Exemplary payment methods may include, but are not limited to traditional payments and/or emergency payments. In an emergency payment, an immediate payment may be submitted to a payee on behalf of the payor 104. In a traditional payment, a payment may be submitted to a payee on behalf of the payor 104 in accordance with a traditional risk assessment following the receipt of a payment request from the payor 104. Accordingly, in a traditional payment, a risk assessment may be utilized following the receipt of a payment request to determine whether an electronic payment or a paper payment will be submitted on behalf of a payor 104. The payment service provider 102 may identify one or more available payment methods utilizing a similar process to that utilized to identify available funding methods. For purposes of the present disclosure, systems, methods, and processes for identifying available funding methods are described; however, it will be understood that the described systems, methods, and processes may be easily modified in order to identify available payment methods.

According to an aspect of the present invention, one or more graphical user interface screens may be displayed to the payor 104 and utilized in the display of available funding methods to the payor 104 and/or the submission of payment requests to the payment service provider 102. A portion or all of the graphical user interface screens may be communicated over the network 100 to the payor 104 by the payment service provider 102 and then displayed to the payor 104. For example, graphical user interface screens may be communicated to the payor 104 over the Internet and then displayed to the payor 104 via an Internet web browser running on a personal computer associated with the payor 104. The payor 104 may input information into the graphical user interface screens that is then communicated back to the payment service provider 102. It will be appreciated that the graphical user interface screens may also be communicated to the payor 104 by one or more other entities such as, for example, by a sponsor. In such a situation, the payor 104 may be in communication with the sponsor and the payment service provider 102 may be in communication with the sponsor. As an example, the sponsor may be a financial institution in communication with the payor 104. The payor 104 may communicate with the financial institution via graphical user interface screens and the financial institution may be in communication with the payment service provider 102. It will also be understood that the payor 104 may be in communication with both a payment service provider 102 and one or more other entities. Additionally, in a situation where the payor 104 is in direct communication with a payee, the graphical user interface screens may be communicated or transmitted to the payor 104 by the payee. It will also be understood that a graphical user interface screen may be generated by one entity such as, for example, a sponsor or a payee, and communicated either directly to the payor 104 or indirectly to the payor 104 through one or more other entities such as, for example, a payment service provider 102.

FIGS. 3-4A and 6 are exemplary flowcharts of the control logic utilized by the control unit 200 of FIG. 2, according to an illustrative embodiment of the present invention. The control logic may be within the programmed logic 215 stored in the memory 205 of the control unit 200 of the payment service provider 102. Alternatively, the control logic may be disposed on a single component or distributed among a plurality of the components of the network 100.

FIG. 3 is a high level flowchart of the control logic utilized by the control unit 200 to determine or identify one or more available funding methods for submitting a payment on behalf of the payor 104 and then to facilitate the selection of a funding method by the payor 104 for submitting a payment. The steps shown in FIG. 3 may be executed to determine one or more available funding methods prior to the receipt of a payment request from the payor 104. Following the identification of available funding methods, the payor 104 may select an available funding method in a payment request. The payment request may be a request for the payment service provider 102 to submit an emergency payment to a payee on behalf of the payor. The steps shown in FIG. 3 may be utilized to facilitate any payment by the payor 104 including an emergency payment.

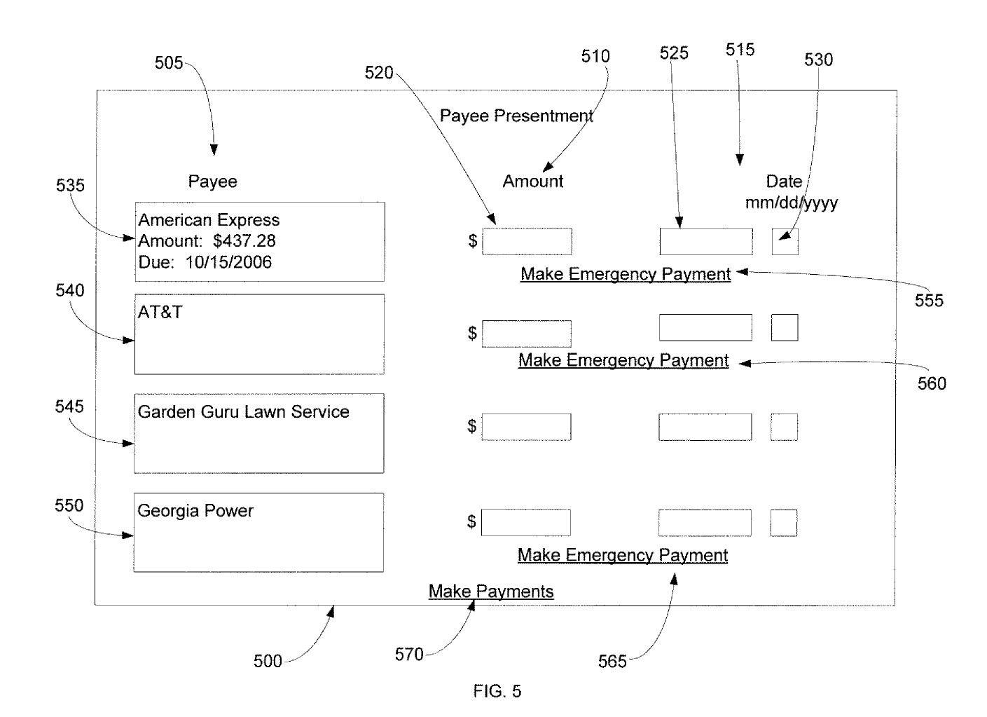

With reference to FIG. 3, at step 305, the control unit 200 may identify one or more potential payees 535, 540, 545, and 550, as explained in greater detail below with reference to FIG. 5. The identified payees 535, 540, 545, and 550 may be payees that have been identified by the payor 104 or payees that have transmitted billing information to the payment service provider 102 for the payor 104. For example, a payee 535, 540, 545, or 550 may be identified based on a selection of the payee 535, 540, 545, or 550 by the payor from list of payees 535, 540, 545, and 550 that the payment service provider 102 is capable of submitting payments to. As another example, a payee 535, 540, 545, or 550 may be identified by receiving information concerning the payee 535, 540, 545, or 550 from the payor 104. As yet another example, a payee 535, 540, 545, or 550 may be identified based on billing information that is transmitted to the payment service provider 102 by the payee 535, 540, 545, or 550 for the payor 104. A payee 535, 540, 545, or 550 may also be identified based on previous payments or previous payment requests that have been submitted to the payment service provider 102 such as, for example, a recurring monthly payment to the payee 535, 540, 545, or 550. It will be understood that the control unit 200 may store and maintain a list of payees 535, 540, 545, and 550 that have been established for the payor 104.

Once a list of one or more potential payees 535, 540, 545, and 550 has been obtained at step 305, the control unit 200 may go to step 310. At step 310, the control unit 102 may determine whether one or more funding methods are available to the payor 104 in order to submit a payment to each of the identified payees 535, 540, 545, and 550. According to an aspect of the present invention, the determination of available funding methods may be based at least in part on one or more risk-based criteria, as explained in greater detail below with reference to FIG. 4A. According to another aspect of the present invention, the determination of available funding methods may be made prior to receiving a payment request from the payor 104.

Following the determination of available funding methods at step 310, the control unit 200 may go to step 315. At step 315, the control unit 200 may display the identified payees 535, 540, 545, and 550 to the payor 104. The identified payees 535, 540, 545, and 550 may be displayed to the payor 104 via an appropriate graphical user interface communicated to the payor 104. For each identified payee 535, 540, 545, or 550, if the control unit 200 has determined that there is at least one available funding method, then the control unit 200 may display a payment option to the payor 104, as explained in greater detail below with reference to FIG. 5. The displayed payment option may be selected by the payor 104 in order to submit a payment request to the payment service provider 102 for the payee 535, 540, 545, or 550 associated with the displayed payment option. Alternatively, a list of the available funding methods associated with each payee 535, 540, 545, or 550 may be displayed to the payor 104, and the payor 104 may select an available funding method from the list to initiate a payment request. It will be understood that the list of available funding methods associated with each payee 535, 540, 545, or 550 may be displayed to the payor 104 as a static list, as a drop-down menu, as a pop-up window, or by any other suitable interface technique. It will further be understood that a single payment option may be displayed to the payor 104 that is selectable by the payor 104 to request payments to more than one of the payees 535, 540, 545, and 550.

Once the identified payees 535, 540, 545, and 550 and payment options have been displayed to the payor 104 at step 315, the payor 104 may elect to make a payment or submit a payment request. The control unit 200 may receive an election from the payor 104 to make a payment at step 320. The payor 104 may elect to make a payment by selecting a displayed payment option associated with a payee 535, 540, 545, or 550. It will be understood that the displayed payment option may be a selectable link such as, for example, a selectable hypertext link that may be communicated to the payor 104 via the network 100. Selection of the displayed payment option may cause the control unit 200 to communicate or transmit one or more graphical user interface screens to the payor 104 to facilitate the receipt and processing of payment information from the payor 104, as discussed in greater detail below.

If the payor elects to make a payment at step 320, then the control unit 200 may go to step 325. At step 325, the control unit 200 may facilitate the receipt of payment information from the payor 104 and confirmation of the payment request by the payor 104. The payor 104 may enter payment related information such as, for example, an amount of the payment, a date for the payment, and a funding account with which to make the payment. In the event of an emergency payment request, the date for the payment may be preset by payment service provider 102 to be either the current date or any other appropriate date such as, for example, a date prior to a due date associated with the payment. After entering appropriate payment related information, the payor 104 may review the entered information and confirm the payment request. The control unit 200 may then go to step 330.

At step 330, the control unit 200 may verity the received payment related information. The received payment related information may be verified against a number of processing rules. For example, the received payment related information may be verified against established payment limits or payment thresholds associated with the payor 104, the payee 535, 540, 545, or 550, the payment service provider 102, and/or the funding method selected by the payor 104. It will be understood that the received payment related information may be verified against any number of processing rules including one or more risk-based processing rules or criteria, as explained in greater detail below with reference to FIG. 4A. It will further be understood that the processing performed at step 330 may be similar to the processing performed at step 310, although the processing at step 330 occurs subsequent to the receipt of a payment request from the payor 104.

Following the verification of payment related information at step 330, the processor 200 may go to optional step 335. At step 335, the processor 200 may cause the payment service provider 102 to notify the payee 535, 540, 545, or 550 of the payment being submitted on behalf of the payor 104. The notification to the payee 535, 540, 545, or 550 may be an immediate notification transmitted from or communicated from the payment service provider 102. The notification may be electronically communicated over the network 100 to the payee 535, 540, 545, or 550 or to a representative of the payee 535, 540, 545, or 550. Notifying the payee 535, 540, 545, or 550 of the payment may be desired in the case of an emergency payment or an immediate payment. In a situation in which the payor 104 is requesting an emergency payment, the payor 104 may be attempting to avoid penalties such as, for example, late fees or service shut-off by a payee.

After the payee 535, 540, 545, or 550 has been notified of the payment at step 335, the control unit 200 may go to step 340. Alternatively, if optional step 335 is not carried out, then the control unit 200 may go to step 340 from step 330. At step 330, the control unit 200 may handle remittance and settlement for the payment to the payee 535, 540, 545, or 550 on behalf of the payor 104. Remittance may include the submission of a payment and/or remittance advice to the payee 535, 540, 545, or 550. For remittance, an account associated with the payee 535, 540, 545, or 550 may be credited. Typically, a corresponding debit may be made to an account associated with the payor 104 or to an account associated with the payment service provider 102. Settlement may include the acquisition or collection of funds by the payment service provider 102 from the payor 104. For example, if a payment submitted to the payee 535, 540, 545, or 550 was drawn from an account associated with the payment service provider 102, then settlement may include the collection of funds by the payment service provider 102 from an account associated with the payor 104. Settlement may also include the collection of service charges or others fees by the payment service provider 102 from the payor 104. Service charges may be collected from the payor 104 for the submission of payments made on behalf of the payor 104 such as, for example, emergency payments.

According to an embodiment of the present invention, a remittance to a payee 535, 540, 545, or 550 may occur prior to a settlement with the payor 104. In other words, the payment service provider 102 may submit a payment to a payee 535, 540, 545, or 550 on behalf of the payor 104 prior to collecting funds from the payor 104. According to another embodiment of the present inventions a remittance or credit may be guaranteed to the payee 535, 540, 545, or 550 regardless of whether funds are collected from the payor 104. In other words, the payee 535, 540, 545, or 550 may be guaranteed to receive funds for a payment even if the payment service provider 102 is unable to collect from the payor 104 in a settlement action. A guaranteed payment to the payee 535, 540, 545, or 550 may make emergency payments and the ability to receive emergency payments more attractive to the payees 535, 540, 545, and 550. In the case of an emergency payment, a payee may be guaranteed payment and the payment service provider 102 may bear the responsibility of collecting or recouping funds from the payor 104. Although an embodiment of the invention is described in which payment is guaranteed to the payee 535, 540, 545, or 550, it will be understood that other embodiments of the present invention may not guarantee payment to a payee 535, 540, 545, or 550.

It will be appreciated that the steps described and shown in FIG. 3 may be carried out or performed in any suitable order. It will also be appreciated that not all of the steps described in FIG. 3 need to be performed in accordance with the present invention and/or that additional steps may be performed in accordance with the present invention.

FIG. 4A is a high level flowchart of the control logic utilized by the control unit 200 at step 310 of FIG. 3 to determine or identify one or more available funding methods that a payor 104 may utilize to make a payment to a payee. The steps shown in FIG. 4A may be executed by the control unit 200 to determine one or more available funding methods prior to receiving a payment request from the payor 104. Available funding methods may be determined for any payment or potential payment by the payor 104 including an emergency payment. Additionally, the identification of available funding methods may be utilized by the control unit 200 in order to determine whether or not a payor 104 will be permitted to request an emergency payment. The control unit 200 may evaluate a wide variety of criteria, attributes, or factors in determining available funding methods. These criteria may be risk-based criteria that relate to the payment service provider 102, a consumer service provider or sponsor, the payor 104, and/or to the potential payees 535, 540, 545, and 550. It will be understood that the control unit 200 may further evaluate criteria relating to any other entity. Additionally, it will be understood that these criteria may be stored in the memory 205 of the control unit 200. Alternatively, these criteria may be stored remotely to the control unit 200 and communicated to the control unit 200.

With reference to FIG. 4A, the control unit 200 begins the determination or identification of available funding methods for a payor 104 at step 405. At step 405, the control unit 200 may examine criteria associated with the payment service provider 102. It will be appreciated that many different criteria associated with the payment service provider 102 may be examined such as, for example, a determination as to which funding methods are available for electronic payments, a determination as to whether or not the payment service provider 102 permits emergency payments, and a determination as to whether or not a payment velocity limit associated with the payment service provider 102 has been exceeded. It will be appreciated that certain funding methods may be available for electronic payment while other funding methods may not be available for electronic payment. For example, a funding method that utilizes a credit card or a payment made over the Automated Clearing House (ACH) network may be available for electronic payment while a funding method that utilizes a paper check or draft may not be available for electronic payment. It will also be appreciated that certain funding methods may not be supported by the payment service provider 102. For example, the payment service provider 102 may support a payment made over the ACH network, but may not support a credit card payment. As another example, the payment service provider 102 may support credit card payments, but may limit credit card funding methods to credit cards issued by certain credit card issuers. For example, the payment service provider 102 may support credit card payments that utilize a VISA™-branded credit card, but may not support credit card payments that utilize a DISCOVER™-branded credit card. It will be appreciated that the payment service provider 102 may support a wide variety of funding methods such as, for example, ACH payments, credit card payments, debit card payments, payments made with a stored value card, payments made with a money order, and cash payments; however, the payment service provider 102 may not support the making of electronic payments and/or emergency payments utilizing one or more of the funding methods supported by the payment service provider 102. It will further be appreciated that any number of criteria associated with the payment service provider 102 may be utilized in accordance with the present invention. After the criteria associated with the payment service provider 102 have been examined at step 405, the control unit 200 may go to step 410.

A payment velocity limit associated with the payment service provider 102 may be a limit that determines whether or not a preset payment amount has been exceeded for one or more funding methods. For example, a payment velocity limit may be utilized to determine whether the sum of one or more payments that have been made on behalf of a payor 104 with one or more funding method during a predetermined time period exceeds a threshold amount. It will be understood that the payment service provider 102 may utilize virtually any threshold amount and virtually any predetermined time period in order to make this determination. For instance, the payment service provider 102 may determine whether or not the sum of all of the payments made on behalf of a payor 104 within the last month utilizing a particular funding method exceeds a threshold amount. As another example, the payment service provider 102 may determine whether or not the sum of all of the payments made on behalf of the payor 104 within the last week utilizing all of the funding methods potentially available for an electronic or an emergency payment exceeds a threshold amount. It will further be understood that varying payment velocity limits may be established for or associated with a payor 104 depending on one or more criteria associated with the payor 104 such as, for example, a status of the payor 104 with the payment service provider 102. For example, a valued customer of the payment service provider 102 may be associated with a higher payment velocity than a customer that has written some bad checks in the past or that has overdrawn a credit card account. FIG. 41B is a table depicting exemplary payment velocity levels that may be associated with a payor 104. As shown in FIG. 4B, three categories or levels of payors may be established by the payment service provider 102; however, it will be understood that any number of categories may be established. The first established category may be a VIP category in which a payor 104 is associated with a first payment velocity limit such as, for example, $50,000. If a payor 104 falls within the VIP category, then the payor 104 may be permitted to request that the payment service provider 102 submit up to $50,000 in emergency payments on behalf of the payor 104 during the predetermined time period. The predetermined time period may be any time period such as for example, one month. The second established category may be a category for payors that currently have or that typically maintain a bank account balance above a certain threshold amount. The threshold amount may be any amount such as, for example, $5,000. If a payor 104 falls within the second established category, then the payor 104 may be associated with a second payment velocity limit such as, for example, $10,000. The payor 104 may be permitted to request that the payment service provider 102 submit up to $10,000 in emergency payments on behalf of the payor 104 during the predetermined time period. The third established category may be a category for payors that currently have or that typically maintain a bank account balance below a certain threshold amount. A payor 104 that falls within the third established category may be associated with a third payment velocity limit such as, for example, $500. The payor 104 may be permitted to request that the payment service provider 102 submit up to $500 in emergency payments on behalf of the payor 104 during the predetermined time period. Although the distinctions between the categories depicted in FIG. 4B are based on a payor status and/or an account balance, it will be appreciated that the payment service provider 102 may distinguish between various categories of payors based on any number of criteria or factors including, but not limited to, a history associated with the payor 104 and/or a risk profile associated with the payor 104. It will also be appreciated that the various payment velocity limits may be virtually any amounts and that those depicted in FIG. 4B are merely exemplary payment velocity limits.

With reference back to FIG. 4A, at step 410, the control unit 200 may examine criteria associated with a consumer service provider. A consumer service provider may be an entity other than the payment service provider 102 that is acting on behalf of the payor 104 such as, for example, a sponsor of the payor 104. Examples of consumer service providers may include financial institutions, brokerage firms, and credit card companies. The criteria associated with a consumer service provider may include a determination as to which funding methods are available for electronic payments, a determination as to whether or not the consumer service provider permits emergency payments, and a determination as to whether or not a payment velocity limit associated with the consumer service provider has been exceeded. It will be appreciated that certain finding methods may be available for electronic payment by or through the consumer service provider such as, for example, a credit card payment or a debit card payment while other funding methods may not be available for electronic payment. Similar to the payment service provider 102, the payment velocity limit established by the consumer service provider may be a payment velocity limit associated with a particular payor 104 and that the payment velocity limit may be used to determine whether or not a preset payment amount has been exceeded for one or more funding methods. It will be appreciated that the consumer service provider criteria discussed above are exemplary criteria and that any number of criteria associated with a consumer service provider may be utilized in accordance with the present invention.

After the criteria associated with a consumer service provider have been examined at step 410, the control unit 200 may go to step 415. At step 415, the control unit 200 may begin an iterative process in which certain criteria are examined for each of the identified potential payees 535, 540, 545, and 550. At step 415, the control unit may select the next potential payee 535, 540, 545, or 550 and then go to step 420.

At step 420, the control unit 200 may examine criteria associated with the next potential payee 535, 540, 545, or 550 or the currently examined payee 535, 540, 545, or 550. The payee criteria may include a determination as to an account status of a payee 535, 540, 545, or 550 with the payment service provider 102, a determination as to which funding methods are available for electronic payments to the payee 535, 540, 545, or 550, a determination as to whether or not the payee 535, 540, 545, or 550 accepts emergency payments, a minimum number of previous payments made on behalf of the payor 104 to the payee 535, 540, 545, or 550, a determination as to whether a payment velocity limit associated with the payee 535, 540, 545, or 550 has been exceeded, and a time duration since the payee 535, 540, 545, or 550 has been established as a payee of the payor 104. The status of the payee 535, 540, 545, or 550 with the payment service provider 102 may include any payee status such as, for example, whether the payee 535, 540, 545, or 550 is a managed payee of the payment service provider 102 or whether a preferred remittance technique has been established between the payee 535, 540, 545, or 550 and the payment service provider 102. It will be appreciated that certain funding methods may be available for electronic payment to a payee 535, 540, 545, or 550 while other funding methods are not available. For example, if the payee 535, 540, 545, or 550 is a credit card company, an ACH payment may be accepted as an electronic payment while a credit card payment may not be accepted. Such a criteria may prevent a payor 104 from paying a credit card bill with the same credit card that forms the bases for the bill. The time duration since the payee 535, 540, 545, or 550 was added by the payor 104 may be the time duration since the payee 535, 540, 545, or 550 was added to the memory 205 of the control unit 200 of the payment service provider 102 by the payor 104. The time duration since the payee 535, 540, 545, or 550 was added by the payor 104 may additionally or alternatively examine the length of time that the payor 104 has had an account with or been associated with the payee 535, 540, 545, or 550. The number of previous payments from the payor 104 to the payee 535, 540, 545, or 550 may include the number of previous electronic and/or non-electronic payments made by the payment service provider 102 to the payee 535, 540, 545, or 550 on behalf of the payor 104. Previous non-electronic payments made to a payee 535, 540, 545, or 550 capable of receiving electronic payments may indicate a previous failure by the payor 104 of certain risk-based criteria examined by the payment service provider 102. Similar to the payment service provider 102 and the consumer service provider, the payment velocity limit established by the payee 535, 540, 545, or 550 may be a payment velocity limit associated with a particular payor 104 and that the payment velocity limit may be used to determine whether or not a preset payment amount has been exceeded for one or more funding methods.

Following the examination of payee criteria at step 420, the control unit 200 may go to step 425 and examine criteria associated with the payor 104. Exemplary payor criteria may include payor eligibility for each funding method, a status associated with the payor 104, a risk profile or risk assessment associated with the payor 104, a time duration since the finding method was added by the payor 104, an account balance of the payor 104, and a determination as to whether a payment velocity limit associated with the payor 104 has been exceeded. The payor eligibility for each funding method may determine whether or not a payor 104 may utilize a particular funding method in order to make a payment. In the example of a credit card as a potential funding method, the control unit 200 may determine whether or not the existence of any credit card accounts has been established by the payor 104 at the payment service provider 102. The status associated with the payor 104 may include any payor status such as, for example, whether the payor 104 is in good standing with the payment service provider 102 or whether a collection action has been instituted against the payor 104. The risk profile associated with the payor 104 may include, for example, the payment history of the payor 104, the number of payments returned for the payor 104, and the amount of time that the payor 104 has utilized the payment service provider 102 or had an account established with the payment service provider 102. The risk profile may specifically examine the history of the payor 104 including any positive and/or negative history associated with the payor 104. The history examined by the control unit 200 may be history that has occurred in a previous period of time. The previous period of time may have a fixed duration or, alternatively, may include all or a portion of the payor's prior history with the payment service provider 102. For example, the history of the payor 104 may be examined for the past two months, six months, or one year.

Returning to the exemplary payor criteria, the time duration since the funding method was added by the payor 104 may be the time duration that the funding method was added to the memory 205 of the control unit 200 of the payment service provider 102 by the payor 104. The time duration since the funding method was added may additionally or alternatively examine the length of time that the payor 104 has been associated with the funding method. For example, the time duration that a payor 104 has had a checking account and/or the amount of time that the checking account has been established with the consumer service provider may be examined. The account balance of a particular funding method may be examined if the account balance is known. For example, the account balance of a checking account may be examined whereas the account balance of a credit card account may not be known. It will be appreciated that the payor criteria discussed above are exemplary criteria and that any number of criteria associated with a payor 104 may be utilized in accordance with the present invention. The examination and determination as to whether a payment velocity limit has been exceeded is similar to those determination described above with respect to the payment service provider 102, a consumer service provider, and a payee 535, 540, 545, or 550.

Following the examination of payor criteria at step 425, the control unit 200 may go to step 430 and examine risk and fraud criteria. Exemplary risk and fraud criteria may include an open-to-buy amount and one or more rules or criteria based on 30-day or life-to-date counts. An open-to-buy amount may apply to any funding method and may be used to reject new payment requests once an open-to-buy threshold has been reached. For example, a credit card account may have an associated open-to-buy threshold. The open-to-buy threshold for the credit card account may be, for example, the amount of the credit limit for the credit card minus both the amount of the credit limit used and the amount of the authorized transactions for the credit card. A 30-day or life-to-date count may track the payment amounts of transactions and/or the number of transactions or charges made utilizing a particular funding method in the most recent 30-day period or over the life of the payor's account with the particular funding method. It will be understood that the 30-day and life-to-date periods discussed above are merely exemplary periods and that any length of time or period may be examined. It will be appreciated that the risk and fraud criteria discussed above are exemplary criteria and that any number of risk and fraud criteria may be utilized in accordance with the present invention.

Once the risk and fraud criteria have been examined at step 430, the control unit 200 may go to step 435 and determine the funding methods that will be available to the payor 104 for submitting a payment to the currently examined potential payee 535, 540, 545, or 550. The available funding methods determined at step 430 may include one or more of the potential funding methods that are offered by the payment service provider 102 for the submission of payments to the examined payee 535, 540, 545, or 550. Additionally, the available funding methods determined at step 430 may include the funding methods available to the payor 104 for submitting an emergency payment to the examined payee 535, 540, 545, or 550. An example of the determination of available funding methods for a payee 535, 540, 545, or 550 is given below with reference to FIGS. 4C-4D.

Following the determination of the available funding methods for the currently examined payee 535, 540, 545, or 550 at step 435, the control unit 200 may go to step 440. At step 440, the control unit 200 may determine whether there are any other potential payees 535, 540, 545, or 550 to evaluate. In other words, the control unit 200 may determine whether the currently examined payee 535, 540, 545, or 550 is the last potential payee 535, 540, 545, or 550 to evaluate for the payor 104. If, at step 440, the control unit 200 determines that there are other potential payees 535, 540, 545, or 550 to evaluate, then the control unit 200 may return to step 415 and select the next potential payee 415 for analysis. If, however, at step 440, the control unit 200 determines that there are no other potential payees 535, 540, 545, or 550 for analysis, then the control unit 200 may end its operations for determining available funding methods.

Many different criteria are set forth above that relate to the determination of available funding methods. It will be understood that conflicts might arise between the criteria as the control unit 200 conducts its analysis. Accordingly, it will be understood that a multitude of different priorities and processing rules may be assigned to the different criteria in order to resolve conflicts. For example, each of the criteria may be assigned a priority order and a criteria with a higher priority may trump a criteria with a lower priority. Alternatively, one or more of the criteria may be weighted and the determination of whether or not a funding method will be available to a payor 104 may be based at least in part on a weighted average of more than one criteria.

It will further be appreciated that the steps described and shown in FIG. 4A may be carried out or performed in any suitable order. It will also be appreciated that not all of the steps described in FIG. 4A need to be performed in accordance with the present invention and/or that additional steps may be performed in accordance with the present invention. Additionally, although FIG. 4A describes the examination of criteria prior to receiving a payment request from a payor 104, it will be understood that some or all of the steps depicted in FIG. 4A may be conducted as part of a risk-analysis procedure that is conducted by the payment service provider 102 following the receipt of a payment request from a payor 104.

FIGS. 4C-4D are tables depicting exemplary results of the processing steps of FIG. 4A. FIG. 4C displays a list of potential funding methods examined for each of the payees 535, 540, 545, and 550 and a determination as to whether each of the examined potential funding methods is an available funding method for the payor 104. FIG. 4D displays a list of the maximum payment amounts allowed for each of the potential funding methods. While four payees 535, 540, 545, and 550 and two potential funding methods are shown in FIGS. 4C-4D, it will be understood that any number of payees 535, 540, 545, and 550 and potential funding methods may be analyzed by or utilized in conjunction with the present invention.

As shown in FIG. 4C, four payees 535, 540, 545, or 550 have been analyzed by the control unit 200 of the present invention in order to determine the funding methods that will be available to the payor 104. The payees 535, 540, 545, or 55 listed in FIG. 4C may be payees that have been predefined, pre-selected, or pre-established by payor 104. Alternatively, or in addition to the predefined or pre-selected payees, the payees listed in FIG. 4C may be identified to the payment service provider 102 by the payor 104 via any suitable user input such as, for example, a keyboard and/or a mouse. As explained in greater detail below with reference to FIG. 5, each of the payees 535, 540, 545, and 550 may be a different service provider, vendor, or biller of the payor 104. In the example of FIGS. 4C and 5, the first payee 535 may be a credit card company, the second payee 540 may be a telecommunications provider, the third payee 545 may be a lawn service provider, and the fourth payee 550 may be a utility service provider.

As discussed above, FIG. 4C displays an exemplary analysis of potential funding methods with respect to each of the payees 535, 540, 545, and 550. With respect to the first payee 535, the control unit 200 has determined that the payor 104 will be allowed to submit a payment to the first payee 535 utilizing the ACH network; however, the payor 104 will not be permitted to submit a payment to the first payee 535 utilizing a credit card account. The ACH network may be utilized by the payment service provider 102 to submit a payment on behalf of a payor 104 that is drawn on a demand deposit account associated with either the payor 104 or the payment service provider 102. Based on the criteria examined by the control unit 200, the control unit 200 may prevent a payment to a credit card service provider utilizing a credit card issued by the credit card service provider. By establishing this limitation prior to receiving a payment request the payment service provider 102 may prevent customer irritation on the part of the payor 104 because the payor 104 will not be allowed to select the credit card to make a payment to the first payee 535. If the payor 104 were allowed to select the credit card when making a payment request and the payment service provider 102 later determines that a credit card payment will not be allowed, then it may be frustrating to the payor 104 and lead to a negative user experience. It will be understood that if the payor 104 has established multiple credit card accounts with the payment service provider 102, it may be possible for the payor 104 to submit a payment to one credit card service provider utilizing a separate credit card account; however, it will also be appreciated that the consumer service provider 102 may prevent any payments to credit card service providers utilizing credit card accounts.

With respect to the second payee 540, the control unit 200 may determine based on examined criteria that a payor 104 may submit a payment to the second payee 540 utilizing either a demand deposit account (over the ACH network) or a credit card. With respect to the third payee 545, the control unit 200 may determine that the third payee 545 is not capable of receiving electronic payments. The third payee 545 may not be electronically connected to the payment service provider 102 via the network 100. Accordingly, the control unit 545 may prevent the payor 104 from making a payment to the third payee 545 utilizing either of the electronic funding methods that are examined.

With respect to the fourth payee 550, the control unit 200 may determine based on examined criteria that a payor 104 may submit a payment to the fourth payee 550 utilizing a credit card; however, the payor 104 may not submit a payment to the fourth payee 550 utilizing a demand deposit account. The determination that the payor 104 will not be allowed to make a payment utilizing a demand deposit account may be based on an analysis of the risk profile of the payor 104 by the control unit 200. If for example, the payor 104 has a history of writing bad checks, then the payment service provider 102 may prevent the payor 104 from submitting a payment to the fourth payee 550 via the ACH network. As with the prevention of a credit card payment to the first payee 535, it will be appreciated that preventing the payor 104 from selecting a demand deposit account funding method may help to prevent a negative user experience. Alternatively, the fourth payee 550 may be a payee to which the payment service provider 102 has not previously submitted a payment on behalf of the payor 104. In such a situation, there may be no payment history associated with the payor 104 for the fourth payee 550 and, accordingly, the payment service provider 102 may determine that a payment utilizing a demand deposit account will not be allowed.

Although FIG. 4C displays results for a demand deposit account funding method and for a credit card account funding method, the present invention is not limited to these two funding methods. It will be appreciated that many different funding methods may be utilized in accordance with the present invention such as, for example, credit cards, demand deposit accounts, debit cards, and stored value cards. It will further be appreciated that only electronic funding methods are discussed herein. In order to submit an emergency payment or an immediate payment to a payor 535, 540, 545, or 550, it may be desirable to submit that payment electronically. It will be understood, however, that the payment service provider 102 may be capable of submitting paper payments to a payee 535, 540, 545, or 550 on behalf of the payor 104. Accordingly, paper payment funding methods such as, for example, a check or a draft may be analyzed by the control unit 200 according to one or more criteria prior to receiving a payment request from the payor 104. The submission of paper payments, however, is not discussed herein, because it may not be desirable to submit an emergency payment using a paper method.

FIG. 4D displays the maximum payment amounts allowed for each of the potential funding methods examined by the control unit 200. It will be appreciated that the maximum payment amount may be any non-negative payment amount and it may be the lowest maximum payment amount allowed by the payment service provider 102, a consumer service provider, a payee 535, 540, 545, or 550, and/or the payor 104.

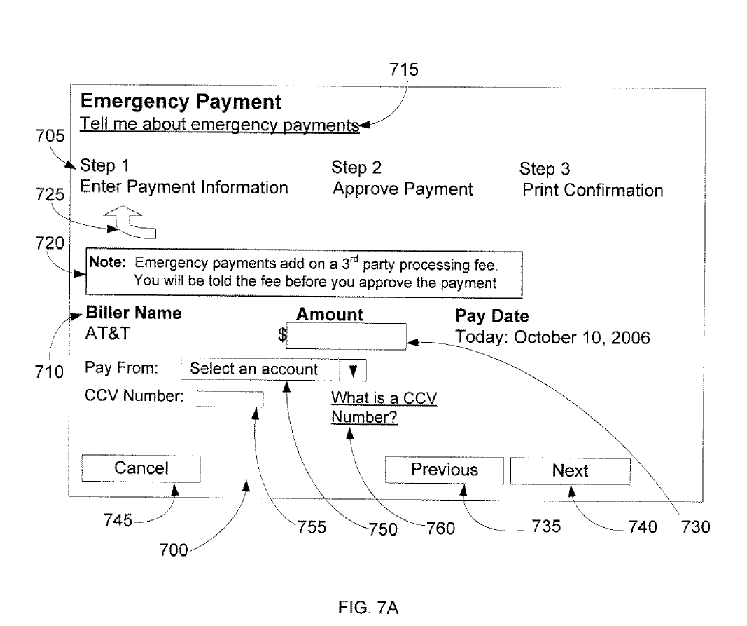

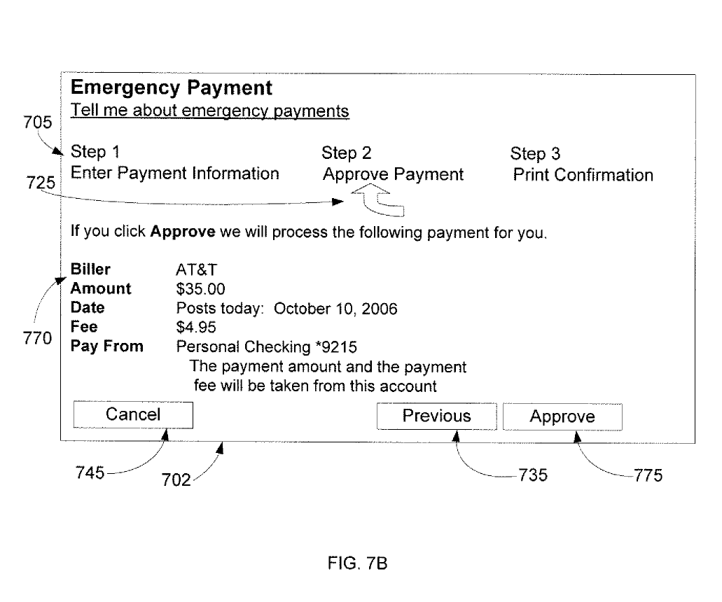

A portion or all of the information displayed in FIGS. 4C and 4D may be displayed to or otherwise communicated to the payor 104. It will be appreciated that a variety of graphical user interface screens may be displayed to the payor 104. These graphical user interface screens may include screens that display at least one payment option to the payor 104. These graphical user interface screens may also relate to submitting payment requests and, in some embodiments, may include screens that relate to the presentment of bills to the payor 104. Exemplary graphical user interface screens are described in greater detail below with reference to FIGS. 5 and 7. Examples of other graphical user interface screens that may be displayed to the payor 104 in addition to those shown in FIGS. 5 and 7 include, but are not limited to, a login and user verification screen, a payor enrollment screen, a payee initialization screen, a summary bill presentment screen, and a detailed bill presentment screen.

According to an aspect of the present invention, a payee presentment screen 500 may be displayed to the payor 104. FIG. 5 is an exemplary payee presentment screen 500 provided to a payor 104 by a payment service provider, according to an illustrative embodiment of the present invention. The payee presentment screen 500 may allow a payor 104 to identify payees 535, 540, 545, or 550 to which the payor 104 desires the payment service provider 102 to submit a payment. Additionally, the payee presentment screen 500 may allow a payor 104 to determine whether or not the payment service provider 102 will permit the payor 104 to make an emergency payment or immediate payment to each of the payees 535, 540, 545, and 550. For each of the payees 535, 540, 545, and 550 depicted in FIG. 5, the payment service provider 102 may have already determined whether or not the payor 104 will be allowed to make one or more types of payments to a payee 535, 540, 545, or 550 such as, for example, an emergency payment. The payment service provider 102 also may have already determined what funding methods will be available to a payor 104 to submit a payment to each of the payees 535, 540, 545, and 550.

As shown in FIG. 5, the payee presentment screen 500 may include a payee column 505, an amount column 510, and a date column 515. The payee column 505 identifies one or more payees which the payor 104 may pay via a payment request. The payees listed in the payee column 505 may be payees that have been predefined, pre-selected, or pre-established by payor 104. Alternatively, or in addition to the predefined or pre-selected payees, the payees listed in the payee column 505 may be entered into the payee column 505 by the payor 104 via any suitable user input such as, for example, a keyboard and/or a mouse. The amount column 510 allows the payor 104 to enter or select a desired monetary amount for a payment request. It will be appreciated that the amount column 510 may additionally or alternatively be pre-populated and presented to the payor 104 based on preferences of the payor 104 and/or billing information received from a payee 535, 540, 545, or 550. A desired monetary amount may be entered into or displayed in an amount box 520 associated with a payee 535, 540, 545, or 550. The date column 515 allows a payor 104 to enter a desired date for payment processing to be initiated or for payment processing to be received by the payee. A desired date may be entered into a date box 525 associated with a payee 535, 540, 545, or 550. Alternatively, a date may be selected by the payor 104 from a calendar by clicking on a calendar link 530 or calendar button associated with a payee 535, 540, 545, or 550. It will be appreciated that the date may be pre-populated and presented to the payor 104 based on preferences of the payor 104 and/or billing information received from the payee 535, 540, 545, or 550. It will be understood by those of skill in the art that a portion of or all of the information that is pre-populated and displayed to a payor 104 in the payee presentment screen 500 may be overridden by the payor 104.

The payee presentment screen 500 of FIG. 5 has four identified payees 535, 540, 545, and 550. An identified payee is a payee that has been established by the payor 104 and may be any payee that is capable of receiving a payment on behalf of the payor 104. The four payees 535, 540, 545, and 550 are exemplary payees for which the payment service provider 102 might receive a payment request. The first payee 535 may be a managed payee that is capable of receiving an electronic payment. A managed payee is a payee about whom the service provider 102 has information that enables a remittance payment to that payee to be handled in some improved/optimal fashion. The information may include one or more of: account schemes for improved reliability of accounts receivable posting at the managed payee, account ranges for remittance center identification, other information for remittance center identification, payee preferred payment form (paper or electronic), payee preferred remittance advice form (paper or electronic, and format/syntax), and electronic communication parameters for delivery of electronic credits and/or electronic remittance advice. The managed payee information may be stored in the memory 205 of the control unit 200 associated with the payment service provider 102. The term electronic managed payee may be used to describe a managed payee that can receive remittance electronically. It will also be appreciated that in many instances the term managed payee may be used to describe a managed payee that is capable of receiving remittance electronically.

For the first payee 535 shown in FIG. 5, the payment service provider 102 may have already received billing information associated with a payment to be made to the first payee 535. For example, the first payee 535 may have communicated or transmitted billing information to the payment service provider 102. The billing information may include data such as, for example, a billing amount and a due date for a bill. This billing information may be presented to the payor 104 by the payment service provider 102 prior to a payment request being received from the payor 104. For example, summary billing information including the next payment amount and due date for the first payee 535 may be presented to the payor 104, as shown in FIG. 5 below the name of the first payee 535.

The second payee 540 may be a managed payee that is capable of receiving an electronic payment from the payment service provider 102. In contrast to the first payee 540, the payment service provider 102 may not have received billing information from the second payee 540. It will be understood, however, that the payment service provider 102 may have information stored in the memory 205 of its control unit 200 that identifies previous payments that have been made to the second identified payee 540. Once the payor 104 identifies the second payee 540 to the payment service provider 102, the information relating to previous payments may be retrieved from the memory 205 and displayed to the payor 104.

The third payee 545 may be an unmanaged payee that is only capable of receiving a paper payment from the payment service provider 102. An unmanaged payee is a payee about whom the payment service provider 102 does not maintain information which aids in the handling of remittance. Accordingly, the payment service provider 102 is unable to submit an electronic payment to the third identified payee 545. A previous payment may or may not have been submitted to an unmanaged payee by the payment service provider 102.

The fourth payee 540 may be a payee to which the payment service provider 102 has not previously submitted a payment on behalf of the payor 104. The fourth payee 335 may be a managed payee. In other words, the payment service provider 102 may have previously submitted or may regularly submit payments to the fourth payee 550 even though no payment has been previously submitted on behalf of the payor 104.

For each of the payees 535, 540, 545, and 550, the payee presentment screen 500 may present at least one payment option if it has been determined that there is at least one available funding method for providing a payment to the payee 535, 540, 545, or 550. The determination of an available funding method(s) may be based at least in part on the criteria discussed above with reference to FIG. 4A. According to an aspect of the present invention, the at least one payment option may be presented to the payor 104 for the purpose of making an emergency payment or an immediate payment to a payee 535, 540, 545, or 550. The at least one payment option may be a selectable link such as, for example, a hypertext link, and selection of the link by the payor 104 may facilitate a payor request for an emergency payment. Utilizing the examples set forth in FIGS. 4C and 4D above, a first payee payment option 555 may be associated with the first payee 535, a second payee payment option 560 may be associated with the second payee 540, and a fourth payee payment option 565 may be associated with the fourth payee 550. In the examples set forth above, it was determined that there were no available funding methods for submitting an electronic payment to the third payee 545. Accordingly, no payment option associated with the third payee 545 is displayed to the payor 104. As an alternative to the single payment options displayed for each payee 535, 540, 545, and 550 in FIG. 5, it will be appreciated that multiple payment options may be displayed for each payee 535, 540, 545, and 550. For example, a payment option relating to each available funding method for a payee 535, 540, 545, or 550 may be associated with the payee 535, 540, 545, or 550 and displayed to the payor 104.

Although the payee payment options 555, 560, and 565 are described above as being presented to the payor 104 if it is determined that there is at least one available funding, it will be appreciated that the determination of whether to allow an emergency payment may be based on any number of criteria. For example, the determination of whether to allow an emergency payment may be based on a status associated with the payor 104. As discussed earlier with reference to FIG. 4A, the status of the payor 104 may be utilized in the determination of available funding methods; however, it will be appreciated that the status of the payor 104 may be utilized to determine whether or not an emergency payment will be allowed for the payor 104. As an example, a determination may be made that a good customer of the payment service provider 102, or a VIP payor, is permitted to request emergency payments due to the payor's status with the payment service provider 102.

In addition to, or as an alternative to, the payee payment options 555, 560, and 565 described above, the payor 104 may also be presented with one or more payment options that are selectable to request non-emergency payments. For example, as shown in FIG. 5, a make payments option 570 may be presented to the payor. Selection of the make payments option 570 by the payor 104 may allow the payor 104 to request the payment service provider 102 to submit a payment to one or more of the payees 535, 540, 545, or 550 on behalf of the payor 104. In processing the one or more received payment requests, the control unit 200 may either utilize pre-stored payment related information, prompt the payor 104 for payment related information, or utilize information entered by the payor 104 on the payee presentment screen 500. For example, the control unit 200 may utilize an amount entered by the payor 104 in the amount box 520 for the first payee 535 and a date entered by the payor 104 in the date box 525 for the first payee 535. As discussed above, the payor 104 may select the make payments option 570 to request payments other than emergency payments. It will be understood that the control unit 200 may not process these payment requests in the same manner that an emergency payment request is processed. For example, the control unit 200 may conduct risk processing after the receipt of a non-emergency payment request, but prior to submitting a payment for the non-emergency payment request. This risk processing may examine many different criteria associated with the payor 104, a payee 535, 540, 545, or 550, a consumer service provider, and/or the payment service provider 102. These criteria may include one or more of the criteria discussed above with reference to FIG. 4A. Additionally, the risk processing may determine whether a payment is submitted on behalf of the payor 104, the method in which the payment is made, and/or the funding method utilized for the payment. For example, if the payor 104 requests a non-emergency payment to the first payee 535, the control unit 200 may first determine that a payment may be made to the first payee 535 on behalf of the payor 104. The control unit 200 may then determine, based on a risk analysis that examines any negative payment history associated with the payor 104, that an electronic payment will not be permitted for this payor. Accordingly, the control unit 200 may determine that any payment made on behalf of the payor 104 will be a paper payment. The control unit 200 may then determine, based at least in part on its risk analysis, that the paper payment will be made by a draft drawn on an account of the payor 104 rather than by a check drawn on an account of the payment service provider 102. It will be understood that a wide array of payment processing and/or risk processing techniques may be utilized by the payment service provider 102 in processing non-emergency payment requests. It will further be appreciated that the processing of an emergency payment request may incorporate one or more of the techniques utilized in processing non-emergency payments.

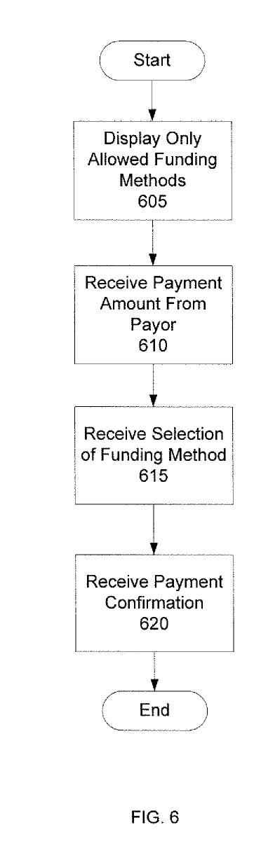

According to an aspect of the present invention, the payor 104 may request the payment service provider 102 to submit an emergency payment on behalf of the payor 104 to a payee 535, 540, 545, or 550 by selecting one of the displayed payment options 555, 560, or 565. When the payor 104 selects one of the displayed payment options 555, 560, or 565, additional graphical user interface screens may be communicated to the payor 104 to facilitate the gathering of information related to the payment request. FIG. 6 is a high level flowchart depicting the operation of the control unit 200 for gathering information from the payor 104 in order to process an emergency payment request. FIGS. 7A-7C depict exemplary graphical user interface screens that may be communicated to a payor to facilitate the steps shown in FIG. 6.

With reference to FIG. 6, at step 605, the control unit 200 may display the available or allowed funding methods to the payor 104 at step prior to the payor 104 entering a payment amount. It will be appreciated that a maximum payment amount may be associated with each of the available funding methods, and the maximum payment amount for each funding method may be displayed to the payor at step 605. After the available funding methods are displayed at step 605, the payor 104 may enter a payment amount at step 610 and the entered payment amount may be communicated to and received by the payment service provider 102. Once the payment amount has been received by the payment service provider 102, the control unit 200 may go to step 615. At step 615, the control unit 200 may support a payor 104 selection of an available funding method. A payor 104 may select an available funding method and that selection may be communicated to and received by the payment service provider 102. It will be appreciated that, prior to receiving a funding method selection, the control unit 200 may further limit the available funding methods based on the payment amount and only the funding methods that are available for submitting a payment for the desired payment amount may be displayed to the payor 104. As an example, if the desired payment amount is $600, then the payment service provider 102 may not display a demand deposit account to the payor 104 because the established maximum payment amount for a demand deposit account is $500. It will be appreciated that a maximum payment amount may also be displayed to the payor 104 at step 605 in order to inform the payor 104 that a ceiling exists for the amount that he or she enters.

After the payor 104 has selected an available funding method at step 615, then the control unit 200 may go to step 620. At step 620, the control unit 200 may confirm any payment information that has been entered by the payor 104 and may then proceed with processing the payment request. In processing the payment request, the control unit 200 may perform additional risk processing on the payment request. The additional risk processing may be similar to that described above with reference to FIG. 4A. The control unit 200 may then carry out remittance to the payee and a settlement process between the payor 104 and the payment service provider 102.

It will be appreciated that the steps described and shown in FIG. 6 may be carried out or performed in any suitable order. It will also be appreciated that not all of the steps described in FIG. 6 need to be performed in accordance with the present invention and/or that additional steps may be performed in accordance with the present invention. It will further be appreciated that the logic displayed in FIG. 6, as well as that displayed in FIG. 4A, may be performed by the control unit 200 in a relatively short period of time such as, for example, while the payor 104 is in a communication session with the payment service provider 102. Performing the majority of the logic in a relatively short period of time may contribute to the payment service provider 102 having an opportunity to interact with the payor 104 via one or more graphical user interfaces.

FIGS. 7A-713 depict exemplary graphical user interface screens that may be displayed to the payor 104 in order to facilitate an emergency payment following the selection of an emergency payment option by the payor 104. FIGS. 7A-7B illustrate sequentially presented interface screens that correspond to the logic depicted in FIG. 6A. FIG. 7A depicts a first emergency payment screen 700 that may be utilized to prompt the payor 104 to enter a desired payment amount and to select an available payment method. As shown in FIG. 7A, the first emergency payment screen 700 may include a process row 705 that lists the necessary steps for submitting an emergency payment request. The first emergency payment screen 700 may also include a payee row 710 that displays information associated with the payee (in this case the second payee 540), the amount of the payment, and the date of the payment. The first emergency payment screen 700 may also include a funding method selection box 750 that may allow the payor 104 to choose an available funding method or funding account. The funding method selection box 750 may be a pull down menu that facilitates the payor selection; however, it will be appreciated that other methods of facilitating a payor selection may be utilized in accordance with the present invention such as, for example, a static list, a pop-up window, or any other suitable interface technique. The first emergency payment screen 700 may also include a CCV number box 755 that allows a payor 104 to enter a credit card verification number if the selected funding method is a credit card. A CCV help link 760 may also be provided, and selection of the CCV help link 760 may cause information relating to the definition and identification of a CCV number to be communicated to the payor 104. The date of the payment may be preset to the current date for an emergency payment. The first emergency payment screen 700 may also include a selectable help or information link 715, a fee notification 720, and a process step indicator 725. The help or information link 715 may be a selectable link, and selection of the link by the payor 104 may cause the payment service provider 102 to communicate information to the payor 104 concerning emergency payments. Exemplary communicated information may be information relating to the definition of emergency payments, the process for submitting emergency payments, and/or frequently asked questions relating to emergency payments. It will be appreciated that the help or information link 715 may also be utilized to commence communication between the payor 104 and a representative of the payment service provider 102 that may assist the payor 104. The fee notification 720 may inform the payor 104 that third party processing fees may be added for an emergency payment. These third party processing fees may be fees required by the payment service provider 102, the consumer service provider, and/or the payee 540 to receive and process an emergency payment. The process step indicator 725 may point to the current step that is being performed in the process row 705. A previous button 735 and a next button 740 may permit the payor 104 to alternate between the various steps of an emergency payment request and a cancel button 745 may permit the payor 104 to cancel the emergency payment request.

As shown in FIG. 7A, the current step is an enter payment information step in which the payor 104 enters a desired amount for the emergency payment and selects an available funding method. The payor 104 may enter a desired amount in an amount box 730 and may also select an available funding method for making the emergency payment. The available funding methods from which the payor 104 may make a selection may be limited according to the steps depicted above with reference to FIG. 4A. The payor 104 may then select a next button 740 to proceed with the emergency payment request. After the payor 104 selects the next button 740, the graphical user interface screen of FIG. 7B may be communicated to and/or displayed to the payor 104.

FIG. 7B depicts a second emergency payment screen 702 that is utilized to prompt the payor 104 to approve the emergency payment request. As shown in FIG. 7B, the process step indicator 725 may point to the second step in the process row 705. Additionally, payment information 770 may be displayed to the payor 104. The payment information 770 may include an identification of the payee 540, an amount of the emergency payment, a fee associated with the emergency payment, a payment date, and an indication of the selected funding method. The second emergency payment screen 702 also includes an approve button 775. If the payor 104 selects the approve button 775, then the emergency payment request may be completed and processed by the payment service provider 102. If, however, the payor 104 selects the cancel button 745, then the emergency payment request may be cancelled. After the emergency payment request is completed, the payor 104 may print a confirmation of the emergency payment request. If the payor 104 chooses to print a confirmation, a printer ready graphical user interface screen may be communicated to and/or displayed to the payor 104. The printer ready graphical user interface screen may contain information relating to the payment request and/or the processing of the payment request such as, for example, the payee 540, the amount of the payment, any fees associated with the payment, and the date of the payment. Alternatively, a confirmation of the emergency payment request may be communicated to the payor 104 by the payment service provider 102 by any appropriate means such as, for example, by electronic mail.

As previously discussed, a fee may be charged to a payor 104 by the payment service provider 102 for the submission of emergency payments on behalf of the payor 104. It will be appreciated that varying levels of fees may be charged to a payor 104 depending on one or more criteria associated with the payor 104 such as, for example, a status of the payor 104 with the payment service provider 102. Such a determination may be similar to that described earlier with respect to varying payment velocity limits.

Although the operation of the control unit 200 as described above with reference to FIGS. 3-4A relates to a determination of available funding methods for a payor 104 prior to receiving a payment request, it will be appreciated that the control unit 200 may also be utilized to determine or identify, prior to receiving a payment request, one or more payment methods that will be available for submitting a payment to a payee 540, 545, 550, or 555 on behalf of a payor 104. As explained earlier, a payment method may be a form of payment or payment processing that is utilized to make a payment on behalf of a payor 104. Exemplary payment methods include, but are not limited to, traditional payments and emergency payment. The steps utilized by the control unit 200 to determine or identify available payment methods may be similar to those utilized to determine or identify available funding methods. The payment service provider 102 may utilize the determination or identification of available payment methods in a wide variety of ways. One potential use for the determination of available payment methods is for a determination as to whether or not one or more payment options are displayed to a payor 104 for requesting a payment. For example, if an electronic payment is not determined to be an available payment method, then the payment service provider 102 may not generate and display an emergency payment option to a payor 104. Another potential use for the determination of available payment methods is for a determination of payment lead times that will be displayed to a payor 104, as described in U.S. patent application Ser. No. 11/565,322. It will be appreciated that there are many other potential uses for the determination of available payment methods by the control unit 200 of the present invention.

According to another aspect of the present invention, the control unit 200 may conduct a risk analysis following the receipt of a payment request from a payor 104 or an entity acting on behalf of the payor 104. This risk analysis may be conducted prior to remitting a payment to a payee 540, 545, 550, or 555. The risk analysis conducted following the receipt of a payment request may be in addition to the risk analysis conducted prior to the receipt of a payment request. Additionally, this risk analysis may be conducted to determine or identify one or more funding accounts or payment options that may be utilized on behalf of a payor 104 to make a payment to a payee 540, 545, 550, or 555. The steps taken by the control unit 200 to conduct a risk analysis following the receipt of a payment request may be similar to those described above with reference to FIGS. 3-4A. Accordingly, the control unit 200 may evaluate a wide variety of criteria, attributes, or factors in conducting a risk analysis following the receipt of a payment request. These criteria may be risk-based criteria that relate to the payment service provider 102, a consumer service provider or sponsor, the payor 104 and/or the potential payees 540, 545, 550, and 555. It will be understood that the control unit 200 may further evaluate criteria relating to any other entity. It will be appreciated that the control unit 200 may evaluate one or more of the criteria described above with reference to FIG. 4A. It will further be appreciated that the control unit 200 may additionally or alternatively evaluate criteria that are not evaluated prior to the receipt of a payment request.

Although the evaluation of criteria relating to a payment amount are discussed above with reference to a risk analysis performed subsequent to the receipt of a payment request, it will be understood that one or more criteria relating to a payment amount may be evaluated in a risk analysis performed prior to the receipt of a payment request. For example, the payment service provider 102 may be capable of receiving billing information for a payee 540, 545, 550, or 555. In such a situation, a payment amount may be processed and/or stored by the payment service provider 102 prior to receiving a payment request from a payor 104. As another example, the payment service provider 102 may conduct a risk analysis that incorporates a payment amount or a theoretical payment amount based on information relating to one or more previous payments submitted to a payee 540, 545, 550, or 555 on behalf of a payor 104. The information relating to one or more previous payments may be stored in the memory 205 of the control unit 200 or in a memory that is accessible by the control unit 200. As an example, the payment service provider 102 may be configured to submit recurring payments to a payee 540, 545, 550, or 555 on behalf of a payor 104. In such a situation, if a payment request is required by the payment service provider 102 prior to submitting a next recurring payment, the payment service provider 102 may be able to determine and process a payment amount prior to receiving the payment request from the payor 104.

The control unit 200 of the payment service provider 102 may evaluate a wide variety of criteria or factors relating to a payment amount. These criteria may relate to the payment service provider 102, a consumer service provider or sponsor, the payor 104 and/or the potential payees 540, 545, 550, and 555. The criteria associated with the payment service provider 102 may include a determination of a maximum payment amount allowed. The maximum payment amount allowed may be a maximum payment amount allowed by the payment service provider 102 for a particular funding method or a maximum payment amount allowed for all funding methods. For example, if the payment amount is $541.00, then the control unit 200 may determine that an electronic emergency payment will not be allowed if a maximum payment criteria establishes a maximum payment amount of $500.00. However, it will be understood that multiple payment amounts may be available for payment to a payee 535, 540, 545, or 550 and a maximum payment criteria may be satisfied if at least one of the multiple payment amounts satisfied the maximum payment criteria. In the example above, even though the billing amount is $541.00, a minimum payment amount of $50.00 may be established by the payee 535, 540, 545, or 550. The control unit 200 may allow an electronic emergency payment of $50.00 or an electronic emergency payment for an amount greater than $50.00 but less than or equal to $500.00 to be made by the payment service provider 102. It will also be understood that a payment service provider 102 may support more than one electronic payment to a payee 535, 540, 545, or 550 on behalf of a payor 104. In such a situation, payments may be made utilizing multiple funding methods and each payment may satisfy a maximum payment amount criteria.

It will be understood that the criteria for a consumer service provider, a payor 104, and a payee 535, 540, 545, or 550 may also include a maximum payment amount that is allowed. Each of these criteria may be tested in a similar manner to that described above with respect to the payment service provider 102. Additionally, for a payee 535, 540, 545, or 550, a determination of the maximum payment amount allowed for a classification or industry type associated with the payee 535, 540, 545, or 550 may also be examined. For example, if the payee 535, 540, 545, or 550 is a credit card company or a utility company, a maximum payment amount may be established for credit card company payments or utility company payments. It will be appreciated that the payee criteria discussed above are exemplary criteria and that any number of criteria associated with a payee 535, 540, 545, or 550 may be utilized in accordance with the present invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
identifying a payee for a payor;
identifying, prior to receiving a payment request to submit a payment the payee on behalf of the payor, at least one funding method from a list comprising one or more potential funding methods that is available to the payor for the payment to the payee, wherein the identification of the at least one funding method is based at least in part on at least one risk-based criteria associated with the payor; and
generating an interface screen for displaying at least one payment option to the payor, wherein the at least one payment option is associated with the at least one funding method.

2. The method of claim 1, wherein the at least one criteria associated with the payor includes at least one of (i) an eligibility of the payor to utilize a potential payment method for payment of the bill, (ii) an amount of time in which the payor has been enrolled with a payment service provider, (iii) a status associated with the payor, (iv) a risk assessment associated with the payor, (v) a payment history associated with the payor, and (vi) a determination of available funds associated with the payor.

3. The method of claim 1, wherein the identification of the at least one funding method is further based at least in part on at least one risk-based criteria associated with the payee.

4. The method of claim 3, wherein the at least one criteria associated with the payee includes at least one of (i) a status associated with the payee, (ii) an indication by the payee to allow a particular funding method, (iii) an indication by the payee to allow a particular payment method, (iv) a minimum number of previous payments made to the payee on behalf of the payor, (v) a determination as to whether a payment velocity limit associated with the payee has been exceeded, and (vi) an elapse of a predetermined time period since the payor established a relationship with the payee.

5. The method of claim 1, wherein the identification of the at least one funding method is further based at least in part on at least one risk-based criteria associated with a payment service provider configured to submit a payment to the payee on behalf of the payor.

6. The method of claim 5, wherein the at least one criteria associated with the payment service provider includes at least one of (i) an ability of the payment service to submit a payment to the payee according to the at least one payment method, and (ii) a determination that a payment velocity limit for the payor has not been exceeded.

7. The method of claim 1, wherein the identification of the at least one funding method is further based at least in part on at least one risk-based criteria associated with a consumer service provider that is associated with the payor.

8. The method of claim 7, wherein the at least one criteria associated with the consumer service provider includes at least one of (i) an indication by the consumer service provider to allow a payment made with a particular funding method, and (ii) a determination that a payment velocity limit for the payor with the consumer service provider has not been exceeded.

9. The method of claim 1, further comprising:
communicating the interface screen to the payor.

10. The method of claim 1, wherein the at least one payment option comprises a selectable link, wherein activation of the selectable link by the payor permits the payor to request a payment to be submitted to the payee on behalf of the payor.

11. The method of claim 1, further comprising:
receiving a payment request from the payor to pay the payee; and
processing the payment request.

12. The method of claim 11, wherein the payment request comprises an indication of one of the at least one funding methods identified as being available to the payor for payment to the payee.

13. The method of claim 11, wherein processing the payment request comprises:
submitting a payment to the payee on behalf of the payor.

14. The method of claim 13, wherein the payment is submitted to the payee prior to a debiting of an account associated with the payor.

15. The method of claim 11, wherein, processing the payment request further comprises:
performing a risk analysis on the received payment request prior to submitting a payment to the payee on behalf of the payor.

16. The method of claim 11, wherein processing the payment request further comprises:
communicating a payment notification to the payee.

17. The method of claim 16, wherein the communication of the payment notification to the payee occurs prior to the submission of the payment to the payee.

18. The method of claim 17, further comprising:
receiving a reply notification from the payee that the payment notification has been received by the payee.

19. The method of claim 18, further comprising:
communicating the reply notification to the payor.

20. The method of claim 1, wherein the one or more potential funding methods comprise at least one of (i) a deposit account, (ii) a debit card associated with a deposit account, (iii) a credit card account, and (iv) a stored-value card.

21. The method of claim 1, wherein the identification of the at least one funding method is based at least in part on at least two risk-based criteria associated with the payor and further comprising:
determining a priority status for each of the at least two risk-based criteria;
determining whether a conflict exists between two or more of the at least two risk-based criteria; and
resolving the conflict based at least in part on the priority status for each of the at least two risk-based criteria.

22. A system comprising:
a processor configured (i) to determine, prior to receiving a payment request to pay a payee on behalf of a payor, at least one funding method from a list comprising one or more potential funding methods that is available to the payor for payment to the payee, wherein the determination of the at least one available funding method is based at least in part on at least one risk-based criteria associated with the payor; and
a network interface configured to transmit at least one payment option to the payor, wherein the at least one payment option is associated with the at least one funding method.

23. The system of claim 22, wherein the at least one criteria associated with the payor includes at least one of (i) an eligibility of the payor to utilize a potential payment method for payment of the bill, (ii) an amount of time in which the payor has been enrolled with a payment service provider, (iii) a status associated with the payor, (iv) a risk assessment associated with the payor, (v) a payment history associated with the payor, and (vi) a determination of available funds associated with the payor.

24. The system of claim 22, wherein the determination of the at least one funding method is further based at least in part on at least one risk-based criteria associated with the payee.

25. The system of claim 24, wherein the at least one criteria associated with the payee includes at least one of (i) a status associated with the payee, (ii) an indication by the payee to allow a particular funding method, (iii) an indication by the payee to allow a particular payment method, (iv) a minimum number of previous payments made to the payee on behalf of the payor, (v) a determination as to whether a payment velocity limit associated with the payee has been exceeded, and (vi) an elapse of a predetermined time period since the payor established a relationship with the payee.

26. The system of claim 22, wherein the determination of the at least one funding method is further based at least in part on at least one risk-based criteria associated with a payment service provider configured to submit a payment to the payee on behalf of the payor.

27. The system of claim 26, wherein the at least one criteria associated with the payment service provider includes at least one of (i) an ability of the payment service to submit a payment to the payee according to the at least one payment method, and (ii) a determination that a payment velocity limit for the payor has not been exceeded.

28. The system of claim 22, wherein the determination of the at least one funding method is further based at least in part on at least one risk-based criteria associated with a consumer service provider that is associated with the payor.

29. The system of claim 28, wherein the at least one criteria associated with the consumer service provider includes at least one of (i) an indication by the consumer service provider to allow a payment made with a particular funding method, and (ii) a determination that a payment velocity limit for the payor with the consumer service provider has not been exceeded.

30. The system of claim 22, wherein the at least one payment option comprises a selectable link, wherein activation of the selectable link by the payor permits the payor to request a payment to be submitted to the payee on behalf of the payor.

31. The system of claim 22, wherein:
the network interface is further configured to receive a payment request from the payor to pay the payee; and
the processor is further configured to process the payment request.

32. The system of claim 31, wherein the payment request comprises an indication of one of the at least one funding methods determined to be available to the payor for payment to the payee.

33. The system of claim 31, wherein:
the processor is further configured to direct the submission of a payment to the payee on behalf of the payor; and
the network interface is further configured to submit the payment to the payee on behalf of the payor.

34. The system of claim 33, wherein the payment is submitted to the payee prior to a debiting of an account associated with the payor.

35. The system of claim 33, wherein:
The processor is further configured to perform a risk analysis on the received payment request prior to directing the submission of a payment to the payee on behalf of the payor.

36. The system of claim 33, wherein:
the processor is further configured to direct the communication of a payment notification to the payee; and
the network interface is further configured to communicate the payment notification to the payee.

37. The system of claim 36, wherein the communication of the payment notification to the payee occurs prior to the submission of the payment to the payee.

38. The system of claim 37, wherein:
the network interface is further configured to receive a reply notification from the payee that the payment notification has been received by the payee.

39. The system of claim 38, wherein:
the processor is further configured to direct the communication of the received reply notification to the payor; and
the network interface is further configured to communicate the received reply notification to the payor.

40. The system of claim 22, wherein the one or more potential funding methods comprise at least one of (i) a deposit account, (ii) a debit card associated with a deposit account, (iii) a credit card account, and (iv) a stored-value card.

41. The system of claim 22, wherein the determination of the at least one funding method is based at least in part on at least two risk-based criteria associated with the payor and wherein the processor is further configured to:
determine a priority status for each of the at least two risk-based criteria;
determine whether a conflict exists between two or more of the at least two risk-based criteria; and
resolve the conflict based at least in part on the priority status for each of the at least two risk-based criteria.

42. A system comprising:
means for identifying a payee for a payor;
means for identifying, prior to receiving a payment request to pay the payee on behalf of the payor, at least one funding method from a list comprising one or more potential funding methods that is available to the payor for payment to the payee, wherein the identification of the at least one funding method is based at least in part on at least one risk-based criteria associated with the payor; and
means for generating an interface screen for displaying at least one payment option to the payor, wherein the at least one payment option is associated with the at least one funding method.
